(19) United States
(12) Patent Application Publication
(10) Pub. No.: US 2017/0120525 A1
(43) Pub. Date: May 4, 2017

(54) 3D Printing Method

(71) Applicant: Shenzhen Longer 3D Technology Co., Ltd., Shenzhen (CN)

(72) Inventors: Ganyang Zhang, Shenzhen (CN); Yang Shen, Shenzhen (CN); Jiajun Han, Shenzhen (CN)

(21) Appl. No.: 15/134,930

(22) Filed: Apr. 21, 2016

(30) Foreign Application Priority Data
Nov. 3, 2015 (CN) 201510749685.4

(51) Int. Cl. B29C 67/00; G05B 15/02

(52) U.S. Cl. CPC B29C 67/0088; G05B 15/02; B33Y 10/00

(57) ABSTRACT

A 3D printing method comprises accessing to a 3D printer; identifying a printing technique type of the 3D printer; identifying a specific model number of the 3D printer; generating a design printing mode of the 3D printer according to the identified printing technique type and specific model number; acquiring a three dimensional model; generating a print file in the design printing mode according to the three dimensional model.

### FIELD OF THE INVENTION

The present invention relates to 3D printing techniques, and particularly relates to a 3D printing method.

### BACKGROUND OF THE INVENTION

The 3D printing technique is to print a 3 dimensional object in a layer by layer printing manner under control of the design software. The 3D printing technique has currently been applied to many fields such as the jewel, the shoe, the industrial design, the automobile and so on. In the 3D printing field, there are many kinds of printing technique types such as fused deposition type, light cure, selective laser sintering, and selective laser melting and so on.

Different printing technique types need to be configured with the 3D printer with corresponding structures to implement the printing process. Meanwhile, even if in the 3D printers having the same printing technique type, the 3D printers of different model numbers remain different in printing speed, size, the range of accuracy and so on. Therefore, in the conventional 3D printing method, each special design software is directed to a specific 3D printer to control the printing process. When a user needs to update the 3D printer or use different 3D printers due to different natures of the objects to be printed to perform the printing process, it all needs to design and install the respective design software to perform the printing process, which leads to increase in use cost and inconvenience for use.

### SUMMARY OF THE INVENTION

On the basis of this, it is necessary to provide a 3D printing method, which can save cost, and is convenient to use by user.

A 3D printing method includes:

accessing to a 3D printer;

identifying a printing technique type of the 3D printer;

identifying a specific model number of the 3D printer;

generating a design printing mode of the 3D printer according to the identified printing technique type and specific model number;

acquiring a three dimensional model; and

generating a print file in the design printing mode according to the three dimensional model.

In one of embodiments, the identifying the printing technique type of the 3D printer includes: identifying the printing technique type by acquiring a characteristic parameter of the 3D printer or receiving input data of a user.

In one of embodiments, the identifying the specific model number of the 3D printer includes: identifying the specific model number by acquiring a characteristic parameter of the 3D printer or receiving input data of a user.

In one of embodiments, the generating the print file in the design printing mode according to the three dimensional model includes: editing the three dimensional model; generating the print file in the design printing mode according to the edited three dimensional model.

In one of embodiments, the generating the print file in the design printing mode according to the three dimensional model further includes: adding a support structure according to the edited three dimensional model; and generating the print file in the design printing mode according to the edited three dimensional model and the support structure.

In one of embodiments, the generating the print file in the design printing mode according to the three dimensional model further includes: determining whether adding the support structure or not according to a user requirement; if yes, then adding the support structure according to the edited three dimensional model, and generating the print file in the design printing mode according to the edited three dimensional model and the support structure; if not, generating the print file in the design printing mode according to the edited three dimensional model.

In one of embodiments, the editing the three dimensional model includes one or more of zooming in, zooming out, translating, and rotating the three dimensional model.

In one of embodiments, the 3D printing method further includes transmitting the 3D print file to the 3D printer.

In one of embodiments, prior to transmitting the 3D print file to the 3D printer, the 3D printing method further includes detecting whether a status of the 3D printer satisfies a printing condition or not in the design printing mode; if yes, transmitting the 3D print file; if not, continuously performing the detection process until the status of the 3D printer satisfies the printing condition.

In one of embodiments, after transmitting the 3D print file to the 3D printer, the 3D printing method further includes monitoring the status of the 3D printer in real time in the design printing mode.

The 3D printing method described above has the following advantages: this 3D printing method generates the design printing mode of the 3D printer by identifying the printing technique type of the 3D printer, the specific model number and then according to the identified printing technique type and specific model number. After the three dimensional model is acquired, the print file is generated in the design printing mode according to the three dimensional model. Therefore, the 3D printing method can be applied to the 3D printers of different types, which overcomes the issue that in the conventional method, when a user needs to update the 3D printer or use different 3D printers due to different natures of the objects to be printed to perform the printing process, it all needs to design and install the respective design software to perform the printing process. The 3D printing method of the invention can save cost, and is convenient for the user.

### BRIEF DESCRIPTION OF THE DRAWINGS

These and other features of the present invention will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 shows a flow chart of a 3D printing method in an embodiment;

FIG. 2 shows a flow chart of step S160 in FIG. 1;

FIG. 3 shows a flow chart of step “generating the print file in the design printing mode according to the edited three dimensional model” in the 3D printing method of another embodiment.

### DETAILED DESCRIPTION OF THE EMBODIMENTS

For facilitating understanding of the present invention, the present invention will be described more fully hereinafter with reference to the related accompanying drawings. The better embodiments are given in the accompanying drawings. The invention may, however, be embodied in many different forms and should not be construed as limited to the embodiments set forth herein. Rather, the object for providing these embodiments is to understand this disclosure of the invention thoroughly and completely.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this invention belongs. Herein terms used in the specification of the invention aim at describing the specific embodiments without limiting the invention. Terms “and/or” used herein comprise any and all combination of one or more related item listed.

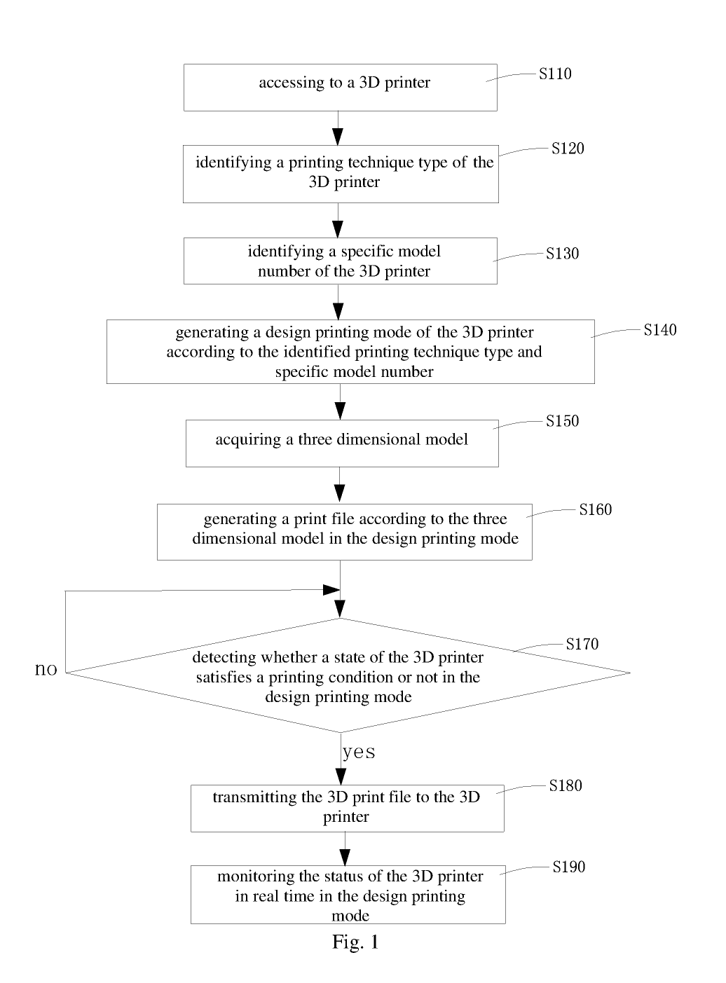

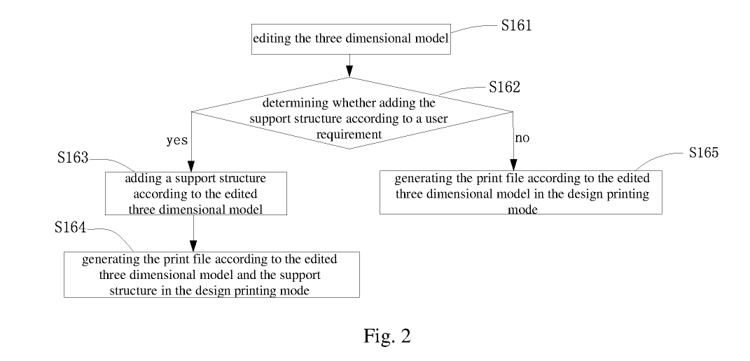

The following detailed description refers to the accompanying drawings that show, by way of illustration, specific details and aspects of this disclosure in which the invention may be practiced. FIG. 1 shows a flow chart of a 3D printing method in an embodiment. FIG. 2 shows a flow chart of step S160 in the 3D printing method of the embodiment shown in FIG. 1.

In one embodiment, a method of controlling any 3D printer by using a 3D printing platform is provided. An interactive operation can be performed between the 3D printing platform and a user, and the 3D printing platform can be implemented in a special software or a backstage server. In the following, the 3D printing method provided by the embodiment is described in detail, and each step is performed by the 3D printing platform.

In step S110, a 3D printer is accessed. For example, a wireless connection module can be employed. The wireless connection module includes a wireless module for receiving or transmitting a signal by wireless, a processor for performing a control function, and an interface for connecting the 3D printer and arranging the 3D printing platform into a mobile phone. When the user uses the 3D printer, the wireless connection module is connected to the 3D printer by the interface, and then the 3D printing platform can communicate with the 3D printer by the wireless connection module.

It should be understood that the 3D printing platform can access the 3D printer by other manners, for instance, the 3D printing platform can be connected to the 3D printer by a wire connection, or in the case that the 3D printer has been connected to a local area network, the 3D printing platform does not need to be connected to the 3D printer, but only needs to search the 3D printer in the local area network. When the 3D printer is found successfully, the 3D printing platform can communicate with the 3D printer over the network.

In step S120, the printing technique type of the 3D printer is identified. Because different printing technique types have different printing manners, the printing parameter classes to be set for different printing manners are different. Therefore, the 3D printing platform firstly needs to identify the printing technique type of the 3D printer, such as fused deposition type, light cure, selective laser sintering and selective laser melting, to determine the corresponding printing parameter class.

In an embodiment, the 3D printing platform can identify the printing technique type of the 3D printer by acquiring the characteristic parameters of the 3D printer. For example, the 3D printing platform can acquire the name of the 3D printer by the wireless connection module or the local area network. Because the name of the 3D printer usually includes information of the printing technique type, the corresponding printing technique type can be acquired according to the name of the 3D printer.

In an embodiment, the 3D printing platform can also identify the printing technique type corresponding to the 3D printer by receiving the input data of the user. For example, an interface is provided by the 3D printing platform for performing an interactive operation with the user. The user can directly input desired printing technique type of the 3D printer for performing the printing operation.

In step S130, the specific model number of the 3D printer is identified. Even if the 3D printers uses the same printing technique type, the printing size, the printing precision and the like required for the 3D printer are different because the natures of objects to be printed are different. Therefore, in the practical use, the 3D printers of the same printing technique type usually have different specific model numbers. When the print file is designed by the 3D printing platform, it needs to control other constraint conditions such as the set range of the printing parameters and the like for the specific model number of the 3D printer, to satisfy requirement of different objects to be printed. Therefore, the 3D printing platform needs to identify the specific model number of the 3D printer.

In an embodiment, the 3D printing platform can identify the specific model number of the 3D printer by acquiring the characteristic parameters of the 3D printer. For example, the 3D printing platform can acquire the name of the 3D printer by the wireless connection module or the local area network. Because the name of the 3D printer usually also includes information of the specific model number, the corresponding specific model number can be acquired according to the name of the 3D printer.

In an embodiment, the 3D printing platform can also identify the specific model number of the 3D printer by receiving the input data of the user. For example, an interface is provided by the 3D printing platform for performing an interactive operation with the user. The user can directly input desired specific model number of the 3D printer for performing the printing operation.

In step S140, the design printing mode corresponding to the 3D printer can be generated according to identified printing technique type and specific model number. After the printing technique type and the specific model number are identified, the 3D printing platform will generate the printing design mode of the 3D printer.

In an embodiment, the 3D printing platform firstly generates the corresponding set mode of printing parameters according to the printing technique type. For example, for the printing technique type of fused deposition, the set mode of printing parameters about the hierarchical thickness, the printing wall thickness, the printing temperature, the printing speed, the filling ratio and the like is generated. For the printing technique type of light cure, the set mode of printing parameters about the hierarchical thickness, the printing speed, the filling ratio and the like is generated. For the printing technique type of selective laser sintering, the set mode of printing parameters about the laser spot, the laser power, the printing speed, the hierarchical thickness, the powder-bed speed, the overlapping ratio and the like is generated. For the printing technique type of selective laser melting, the set mode of printing parameters about the laser spot, the laser power, the printing speed, the hierarchical thickness, the powder-bed speed, the overlapping ratio, the oxygen content, the moisture content, the inert gas pressure and the like is generated.

After the 3D printing platform generates the corresponding set mode of printing parameters according to the printing technique type, the 3D printing platform then sets other constraint conditions such as the adjusting range of each printing parameter and the like according to the specific model number. Finally, the 3D printing platform generates the design printing mode of the 3D printer.

In step S150, the three dimensional model is acquired. In this step, the user can directly input the three dimensional model to be printed, and the 3D printing platform can identify the three dimensional file of different formats, or the 3D printing platform can perform a modeling process by a making software for the three dimensional model according to the user requirement to generate the corresponding three dimensional model.

In step S160, in the above established design printing mode, the 3D printing platform generates the print file according to the three dimensional model.

Referring to FIG. 2, in an embodiment, the specific embodied process of step S160 is as follow:

In step S161, the three dimensional model is edited.

In an embodiment, the editing of the three dimensional model by the 3D printing platform comprises one or more of zooming in, zooming out, translating, and rotating the three dimensional model. The 3D printing platform edits the three dimensional model, which facilitates performing the slice hierarchical process and enables to optimize the printing precision, for improving the printing quality.

In step S162, whether the support structure is added or not is determined according to the user requirement. If the user determines to add the support structure, then step S163 is performed; if the user does not determine to add the support structure, then step S165 is performed.

Because some printing technique types have the particularity in terms of the printing material and manner, the printing process can be performed normally even if there is no support structure during the printing process. In this case, the 3D printing platform can choose to use the support structure or not. For example, when the three dimensional model has a suspended structure of a small angle or is simple, the user can determine whether the support structure is added or not according to the practical case. Therefore, by the manner that the 3D printing platform determines whether the support structure is added or not according to the user requirement, different user requirements can be satisfied.

In step S163, the support structure is added according to the edited three dimensional model. In this step, the user can input set parameters of the support structure, such as the filling ratio, and then the 3D printing platform will add the corresponding support structure according to user input.

In step S164, the print file is generated according to the edited three dimensional model and the support structure in the design printing mode.

In the specific performing process, the 3D printing platform needs to determine the specific value of each printing parameter, for example, for using the printing technique type of fused deposition and the 3D printer of a certain specific model number, the user or the 3D printing platform can set values of the printing parameters such as the hierarchical thickness, the printing wall thickness, the printing temperature, the printing speed, the filling ratio and the like according to the constraint condition. Meanwhile, the 3D printing platform performs the slice hierarchical process for the structure formed by the edited three dimensional model and the support structure according to the related parameters such as the hierarchical thickness, for finally forming the print file including the printing information such as the printing parameter, each sliced cross section and the like.

In step S165, the 3D printing platform generates the print file in the design printing mode according to the edited three dimensional model.

In the specific performing process, the 3D printing platform needs to determine the specific value of each printing parameter, for example, for using the printing technique type of fused deposition and the 3D printer of a certain specific model number, the user or the 3D printing platform can set values of the printing parameters such as the hierarchical thickness, the printing wall thickness, the printing temperature, the printing speed, the filling ratio and the like according to the constraint condition. Meanwhile, the 3D printing platform performs the slice hierarchical process for the edited three dimensional model according to the related parameters such as the hierarchical thickness, for finally forming the print file including the printing information such as the printing parameter, each sliced cross section and the like.

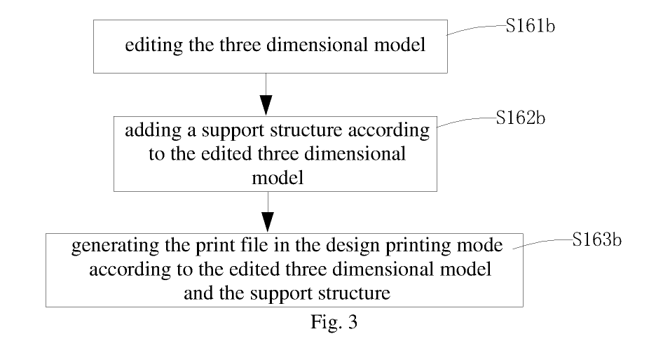

Referring to FIG. 3, in another embodiment, the specific embodied process of step S160 is as follow:

In step S161b, the three dimensional model is edited.

In an embodiment, the editing of the three dimensional model by the 3D printing platform comprises one or more of zooming in, zooming out, translating, and rotating the three dimensional model. The 3D printing platform edits the three dimensional model, which facilitates performing the slice hierarchical process and enables to optimize the printing precision, for improving the printing quality.

In step S162b, the support structure is added according to the edited three dimensional model.

In the specific operation process, because different printing technique types have different printing materials and manners, it intelligently determines whether the support structure needs to be added or not according to different printing technique types when the 3D printing platform adds the support structure, so that the steps operated by the user are avoided. Therefore, this manner can be suited to the user with a higher requirement for the intelligent printing process and the printing speed.

In step S163b, the print file is generated according to the edited three dimensional model and the support structure in the above design printing mode.

In the specific performing process, the 3D printing platform needs to determine the specific value of each printing parameter, for example, for using the printing technique type of fused deposition and the 3D printer of a certain specific model number, the user or the 3D printing platform can set values of the printing parameters such as the hierarchical thickness, the printing wall thickness, the printing temperature, the printing speed, the filling ratio and the like according to the constraint condition. Meanwhile, the 3D printing platform performs the slice hierarchical process for the structure formed by the edited three dimensional model and the support structure according to the related parameters such as the hierarchical thickness, for finally forming the print file including the printing information such as the printing parameter, each sliced cross section and the like.

To sum up, the 3D printing method can identify the three dimensional model tiles of different formats, the printing technique type of the 3D printer and the specific model number, and then generate the design printing mode of the 3D printer according to identified printing technique type and specific model number. After the three dimensional model is acquired, the print file can be generated in the design printing mode according to the three dimensional model. Therefore, the 3D printing method can be applied to the 3D printers of different types, which overcomes the issue that in the conventional method, when a user needs to update the 3D printer or use different 3D printers due to different natures of the objects to be printed to perform the printing process, it all needs to design and install the respective design software to perform the printing process. The 3D printing method of the invention can save cost, and is convenient for use by user.

Referring to FIG. 1 again, in step S170, in the above design printing mode, it detects whether the status of the 3D printer satisfies the printing condition or not. If yes, then step S180 is performed; if not, step S170 is performed repeatedly.

In the specific performing process, the 3D printing platform acquires the status of the 3D printer by the wireless connection module or the local area network. When the 3D printing platform finds the abnormal condition, the user can be noticed by the manner that the abnormal information is displayed on the interactive operating interface.

Then, the printing parameters related to the status of the 3D printer are illustrated. For any printing technique type, the 3D printing platform needs to detect the printing material of the 3D printer until the printing material provided by the user satisfies the printing condition. For the printing technique type of selective laser melting, the 3D printing platform further detects whether the oxygen content, the moisture content and the inert gas pressure satisfy the printing condition or not until the oxygen content, the moisture content and the inert gas pressure satisfy the printing condition by removing oxygen from gas washing, removing moisture from gas washing and adjusting the pressure.

It should be noted that this step can be performed by the 3D printer in practical use. In this case, after the 3D printer detects each parameter satisfies the printing condition, the related instruction will be directly transmitted to the 3D printing platform, so that the 3D printing platform knows the 3D printer is ready.

In step S180, the 3D print file is transmitted to the 3D printer. In the practical operation, the 3D printing platform transmits the print file to the 3D printer in an electrical file manner by the wireless connection module or the local area network. When the 3D printer receives the print file, it starts to perform the printing process.

In step S190, in the design printing mode, the status of the 3D printer is monitored in real time, to ensure the 3D printer can perform the printing process successfully.

In an embodiment, the status of the 3D printer includes parameters such as the printing progress, the oxygen content, the moisture content, the gas pressure and the like. Further, different 3D printers may need to monitor different parameters in real time.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A 3D printing method, comprising:
accessing a 3D printer;
identifying a printing technique type of the 3D printer;
identifying a specific model number of the 3D printer;
generating a design printing mode of the 3D printer according to the identified printing technique type and specific model number;
acquiring a three dimensional model; and
generating a print file in the design printing mode according to the three dimensional model.

2. The 3D printing method of claim 1, wherein identifying the printing technique type corresponding to the 3D printer comprises either identifying the printing technique type by acquiring a characteristic parameter of the 3D printer or receiving input data of a user.

3. The 3D printing method of claim 1, wherein identifying the specific model number of the 3D printer comprises either identifying the specific model number by acquiring a characteristic parameter of the 3D printer or receiving input data of a user.

4. The 3D printing method of claim 1, wherein generating the print file in the design printing mode according to the three dimensional model comprises:
editing the three dimensional model; and
generating the print file in the design printing mode according to the edited three dimensional model.

5. The 3D printing method of claim 4, wherein generating the print file in the design printing mode according to the three dimensional model further comprises:
adding a support structure according to the edited three dimensional model; and
generating the print file in the design printing mode according to the edited three dimensional model and the support structure.

6. The 3D printing method of claim 5, wherein generating the print file in the design printing mode according to the three dimensional model further comprises:
determining whether to add the support structure according to a user requirement;
in response to determining to add the support structure, adding the support structure according to the edited three dimensional model, and generating the print file according to the edited three dimensional model and the support structure in the design printing mode;
in response to determining not to add the support structure, generating the print file according to the edited three dimensional model in the design printing mode.

7. The 3D printing method of claim 4, wherein editing the three dimensional model comprises one or more of zooming in, zooming out, translating, and rotating the three dimensional model.

8. The 3D printing method of claim 4, further comprising transmitting the 3D print file to the 3D printer.

9. The 3D printing method of claim 8, further comprising:
prior to transmitting the 3D print file to the 3D printer, detecting whether a status of the 3D printer satisfies a printing condition in the design printing mode;
in response to detecting that the status of the 3D printer satisfies the printing condition, transmitting the 3D print file to the 3D printer;
in response to detecting that the status of the 3D printer does not satisfies the printing condition, continuously performing the detection process until the status of the 3D printer satisfies the printing condition.

10. The 3D printing method of claim 8, wherein after transmitting the 3D print file to the 3D printer, the method further comprises monitoring the status of the 3D printer in real time in the design printing mode.
